(19) United States
(12) Patent Application Publication
(10) Pub. No.: US 2019/0381476 A1
(43) Pub. Date: Dec. 19, 2019

(54) Photocatalytic Device

(71) Applicant: FLUX PHOTON CORPORATION, Hackensack, NJ (US)

(72) Inventors: CRAIG A. GRIMES, RALEIGH, NC (US); KEVIN KREISLER, HACKENSACK, NJ (US)

(21) Appl. No.: 16/445,473

(22) Filed: Jun. 19, 2019

Related U.S. Application Data
(60) Provisional application No. 62/686,908, filed on Jun. 19, 2018.

(51) Int. Cl. B01J 19/12; B01J 35/00

(52) U.S. Cl. CPC B01J 19/122; B01J 35/0033; B01J 2219/1203; B01J 2219/0875; B01J 2219/0892; B01J 35/004

(57) ABSTRACT

An improved photocatalytic device in which within semiconductors, absorbed electromagnetic radiation is known to generate electron-hole pairs; unwanted recombination of the radiation-generated electrons and holes is a significant limitation of photocatalytic efficiency, while the simultaneous local presence of both electrons and holes at the photocatalyst surface make reaction-specificity difficult to control. A photocatalytic device is described in which radiation-generated electrons and holes are spatially separated to be individually introduced into the reactant flow, minimizing unwanted recombination while promoting reaction-specific outcomes.

### FIELD OF THE INVENTION

The present invention relates to an improved photocatalytic architecture that provides a means for spatially separating radiation-generated electrons and holes, minimizing unwanted electron-hole recombination, that simultaneously improves specificity of desired photocatalytic reactions while minimizing unwanted back reactions.

### BACKGROUND OF THE INVENTION

The current annual global energy consumption roughly corresponds to the energy of the solar light reaching Earth in one hour; using this sunlight to make chemical fuels through photocatalysis offers a viable, and sustainable way to provide needed energy. Recycling of carbon dioxide via conversion into high energy-content fuel suitable for use in the existing hydrocarbon-based energy infrastructure is an intriguing concept for achieving sustainable solar fuels and reducing atmospheric CO₂ concentrations, however this concept is realistically practical only if renewable energy sources are used for the thermodynamically uphill transformation.

Photocatalytic reduction of CO₂ is a complex, multistep process that combines different aspects of light harvesting, charge separation and transfer, and surface science, with overall conversion efficiency determined, in part, by light absorption properties of the semiconductor, electron and hole transport to surface reaction sites, reactant absorption, catalytic reactions, and product desorption; to date photocatalytic CO₂ conversion rates are still quite low. See for example, S. N. Habisreutinger, L. Schmidt-Mende, J. K. Stolarczyk, Photocatalytic reduction of CO₂ on TiO₂ and other semiconductors, Angewandte Reviews 52 (2013) 7372-7408. S. C. Roy, O. K. Varghese, M. Paulose, C. A. Grimes, Toward solar fuels: photocatalytic conversion of carbon dioxide to hydrocarbons, ACS Nano 4 (2010) 1259-1278. Despite almost fifty years of research on the photocatalytic reduction of CO₂, or water photoelectrolysis to cite another photocatalysis-based example, the scientific community is still a long way from efficient and commercially viable devices. By definition a catalytic reaction has a negative difference in the Gibbs free energy, □G⁰<0, so in this strict sense the photocatalytic reduction of CO₂ is not a catalytic process, because it is an uphill reaction requiring a significant energy input, □G⁰>0, which is provided by the incident radiation. However, this inconsistency is commonly ignored, and the process is commonly referred to as being photocatalytic. It is argued, however, that the process instead represents an example of artificial photosynthesis See S. Styring, Artificial photosynthesis for solar fuels, Faraday Discussions 155 (2012) 357-376.

To promote charge separation the radiation-absorbing electron-hole generating photocatalytic semiconductors are commonly sensitized with co-catalysts, of which Pt, Cu, Ag, Au, or Pd nanoparticles are common examples. However while charge separation is promoted by the use of co-catalysts it remains imperfect, and ultimately the presence of both electrons and holes leads to deactivation of the co-catalysts. It has been shown how upon illumination Pd nanoparticles atop TiO₂ soon became PdO nanoparticles atop TiO₂,. See T. Yui, A. Kan, C. Saitoh, K. Koike, T. Ibusuki, O. Ishitani, Photoelectrochemical reduction of CO₂ using TiO₂: effects of organic adsorbates on TiO₂ and deposition of Pd onto TiO₂ have been described see Applied Materials and Interfaces 3 (2011) 2594-2600.

TiO₂ nanotube arrays sensitized with reduced graphene oxide (rGO) have been described as shown in FIG. 1A and FIG. 1B, See A. Razzaq, C. A. Grimes, S. I. In, Facile fabrication of a noble metal-free photocatalyst: TiO₂ nanotube arrays covered with reduced graphene oxide, Carbon 98 (2016) 537-544. Although the rGO-TiO₂ heterojunctions, in this example promote charge transfer and separation, all chemical reactions take place at the same interface. Accordingly, a radiation-generated hole present at the surface might oxidize a water molecule, a desired reaction, or a methane molecule, an undesired back-reaction, and so too, in an analogous sense, with electrons.

An alternative approach to trying to enhance photocatalyst properties is through the synthesis of a photocatalyst comprised of a multitude of pn-heterojunctions has been described as shown in FIG. 2 as described in K. Kim, A. Razzaq, S. Sorcar, Y. Park, C. A. Grimes, S. I. In, Hybrid mesoporous Cu₂ZnSnS₄ (CZTS)-TiO₂ photocatalyst for efficient photocatalytic conversion of CO₂ into CH₄ under solar irradiation, RSC Advances 6 (2016) 38964-38971. In this example, the semiconductor photocatalyst is a composite of p-type Cu₂ZnSnS₄ (CZTS) nanoparticles embedded within an n-type TiO₂ matrix. The material design principal described is that making a composite of two semiconductors of disparate band gap energies will extend the absorption spectrum and that the formation of pn-junctions between the CZTS and TiO₂ nanoparticles will facilitate electron-hole separation and transfer. However in application to photocatalytic reduction of CO₂ it was found that the TiO₂-generated holes were as ready to oxidize the CZTS as they were adsorbed gas molecules, a drawback since in realizing a practical system photocatalyst stability is of utmost importance. FIGS. 3A and 3B are schematic diagrams of a conventional photocatalytic device including metal contacts.

The non-predictable arrival of an electron or hole commonly serves to rapidly deactivate the co-catalyst(s), randomly reaching a (surface) reactant molecule can result in formation of branching pathways that, in turn, can lead to different products arising at the same time. With respect to photocatalytic conversion of CO₂, it is for this reason common effluents include, but are not limited to, carbon monoxide, formic acid, formaldehyde, methanol, methane, ethane, ethane, and ethanol.

It is desirable to provide an improved photocatalytic device without the use of metallic conductors, and without generation of a recognizable electrical current nor potential, minimizing unwanted electron-hole recombination and increasing photocatalyst stability to alleviate the above described shortcomings and achieve much higher photocatalytic conversion efficiencies,

### SUMMARY OF THE INVENTION

It is desirable to use sunlight for transformation of CO₂ and water vapor to hydrocarbon fuels such as methane, ethane, or even higher order hydrocarbons; not only will such solar fuels reduce atmospheric CO₂ emissions but provide a viable means for the storage and transport of solar energy. Given the ability of a semiconductor to absorb radiation and generate an electron-hole pair, photocatalyst efficiency is significantly impacted by the ability of the radiation-generated electrons and holes to avoid unwanted recombination, and the ability to promote specific reaction steps. For example, the photocatalytic conversion of CO2 to fuel requires multiple electron transfers that can lead to the formation of many different products depending upon the number, and direction, of electrons transferred, by which the final oxidation state of the carbon atom is determined. With respect to photocatalytic conversion of CO2, potentially branching pathways can lead to different products arising at the same time, including carbon monoxide, formic acid, formaldehyde, methanol, methane, ethane, ethane, and ethanol.

In one embodiment, the photocatalytic device of the present invention is comprised of a junction made from a p-type semiconductor and an n-type semiconductor. Radiation incident upon the pn-junction results in electron-hole pairs being formed, and due to the built-in electric field across the junction separated the collected electrons and holes are not passed to metallic conductors as done with a conventional photovoltaic device, i.e. they do not enter a sea of electrons to create an electrical potential nor generate a current, nor deliver power to a load. The holes remain in a p-type semiconductor element until exposed to gas molecules, which can be a desired distance away from the pn-junction, and the electrons remain in an n-type semiconductor element until exposed to gas molecules. The gas molecules can be a desired distance away from the pn-junction. The separated charge carrier polarities, electrons or holes, are maintained until intentionally exposed to the reactants, which can be either liquid or gas phase. The present invention is directed to photocatalysis of target molecules, and regardless of application a fundamental building block of photocatalysis is separation of the electrons and holes generated within the semiconductor upon radiation absorption. It is understood from the teachings of the present invention, that the present invention can apply equally to both photocatalysis and photosynthesis. The present invention relates to an improved photocatalytic architecture that provides a means for spatially separating radiation-generated electrons and holes, in a manner analogous to a photovoltaic without the use of metallic conductors, and without generation of a recognizable electrical current nor potential, minimizing unwanted electron-hole recombination and increasing photocatalyst stability. The electrons and holes from the photocatalytic device of the present invention can be directed to interact with gas molecules in certain places and in certain stages of the reaction process for simultaneously improving the specificity of desired photocatalytic reactions while minimizing unwanted back reactions.

In the photocatalytic device in accordance with teachings of the present invention, in which the device is enclosed within a photocatalytic reactor, electron-hole pairs formed within the planar pn-junction, due to absorption of electromagnetic energy, are separated, due to the built-in electric field across the junction, with electrons going to the n-type semiconductor and holes into the p-type semiconductor. The spatial extent of the n-type and p-type regions, along which, respectively, the electrons and holes are free to traverse, allow the holes and electrons to interact with adsorbed molecules independently of each other. Arising from the p-type and n-type regions are, respectively, p-type and n-type high-surface area architectures, such as arrays of nanowires, nanotubes, nanorods, nanofeathers, and the like that enable greater interaction with adsorbed or adjacent molecules.

In one embodiment of the photocatalytic device, the photocatalytic device can be fabricated in wafer form, in which the device is enclosed within a photocatalytic reactor.

In one embodiment of the photocatalytic device, the pn-junction is not within the photocatalytic reactor. The n-type and p-type regions, along which, respectively, the electrons and holes are free to traverse, are arranged to bring their respective charge carriers into one or more photocatalytic reactors, where they can interact with adsorbed or nearby molecules. Arising from the p-type and n-type regions are, respectively, p-type and n-type high-surface area architectures, such as arrays of nanowires, nanotubes, nanorods, nanofeathers, and the like, that enable greater interaction with adsorbed or local molecules.

In one embodiment of the photocatalytic device the pn-junction is within two photocatalytic reactors. Electron-hole pairs formed within the planar pn-junction, due to absorption of electromagnetic energy, are separated, due to the built-in electric field across the junction, with electrons going to the n-type semiconductor and holes into the p-type semiconductor. Arising from the p-type and n-type regions are, respectively, p-type and n-type high-surface area architectures, such as arrays of nanowires, nanotubes, nanorods, nanofeathers, and ordered mesoporous composite, and that enable greater interaction with adsorbed or local molecules.

In one embodiment of the photocatalytic device, a pn-junction is formed between the p-type nanoparticles, or p-type quantum dots, and n-type nanowires in which the nanoparticles/quantum dots are intercalated. Electrons reside within the n-type nanowires, and holes reside within the nanoparticles/quantum dots. The electrons can either react with molecules in contact with the n-type nanowire, or at a spatially distant location where the n-type silicon substrate is again exposed to the ambient.

In one embodiment of the photocatalytic device, p-type semiconductor is connected to an electrical ground, and so the holes disappear from the electrical circuit into the infinite electron sea. Electron-hole pairs formed within the planar pn-junction, due to absorption of electromagnetic energy, are separated, due to the built-in electric field across the junction, with electrons going to the n-type semiconductor and holes into the p-type semiconductor. The spatial extent of the n-type region, along which the electrons are free to traverse, allow the electrons to interact with passing molecules independently of the holes. Arising from the n-type region, within the photocatalytic reactor, are high-surface area n-type architectures, such as arrays of nanowires, nanotubes, nanorods, nanofeathers, and ordered mesoporous layers, that enable greater interaction with adsorbed or adjacent molecules.

In one embodiment of the photocatalytic device, the n-type semiconductor is connected to an electrical ground, and so the electrons disappear from the electrical circuit into the infinite electron sea. Electron-hole pairs formed within the planar pn-junction, due to absorption of electromagnetic energy, are separated, due to the built-in electric field across the junction, with electrons going to the n-type semiconductor and holes into the p-type semiconductor. The spatial extent of the p-type region, along which the holes are free to traverse, allow the holes to interact with passing molecules independently of the electrons. Arising from the p-type region, within the photocatalytic reactor, are high-surface area p-type architectures, such as arrays of nanowires, nanotubes, nanorods, nanofeathers, and ordered mesoporous layers that enable greater interaction with adsorbed or adjacent molecules.

The invention will be more fully described by reference to the following drawings.

### BRIEF DESCRIPTION OF THE DRAWINGS

FIG. 1(a) is a schematic diagram of a prior art photocatalytic system illustrating photocatalytic conversion of CO₂ into CH₄ utilizing reduced graphene-oxide (rGO) sensitized TiO₂ nanotube arrays

FIG. 1(b) is an energy level diagram for a prior art photocatalytic system under simulated solar light.

FIG. 2 is a schematic diagram of a prior art photocatlytic system illustrating photocatalytic conversion of CO₂ into methane by hybrid mesoporous Cu₂ZnSnS₄ (CZTS)-TiO₂ samples under solar spectrum light and a energy level diagram of the photocatalytic system.

FIG. 3(a) is a schematic diagram of a prior art configuration of a solar cell with an enlarged cross-sectional view of the planar junction.

FIG. 3(b) is a top view of FIG. 3(a) showing metal contact fingers.

FIG. 4 is a schematic diagram of a photocatalytic device in accordance with teachings of the present invention in which the device is enclosed within a photocatalytic reactor.

FIG. 5 is a schematic diagram of a photocatalytic device, in which the device is enclosed within a photocatalytic reactor.

FIG. 6 is a schematic diagram of a photocatalytic device, in which photocatalytic device has been fabricated in wafer form, in which the device is enclosed within a photocatalytic reactor.

FIG. 7 is a schematic diagram of a photocatalytic device in which the pn-junction is not within the photocatalytic reactor.

FIG. 8 is a schematic diagram of a photocatalytic device in which the pn-junction is within two photocatalytic reactors.

FIG. 9 is a schematic diagram of a photocatalytic device implementation.

FIG. 10 is a schematic diagram of a photocatalytic device including a p-type semiconductor connected to an electrical ground

FIG. 11 is a schematic diagram of a photocatalytic device including a n-type semiconductor connected to an electrical ground.

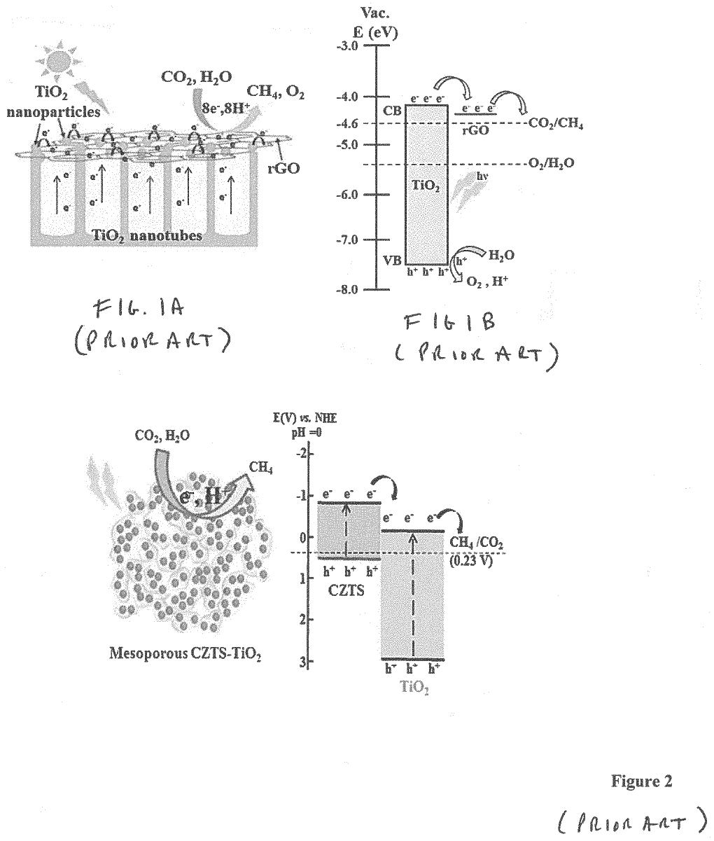

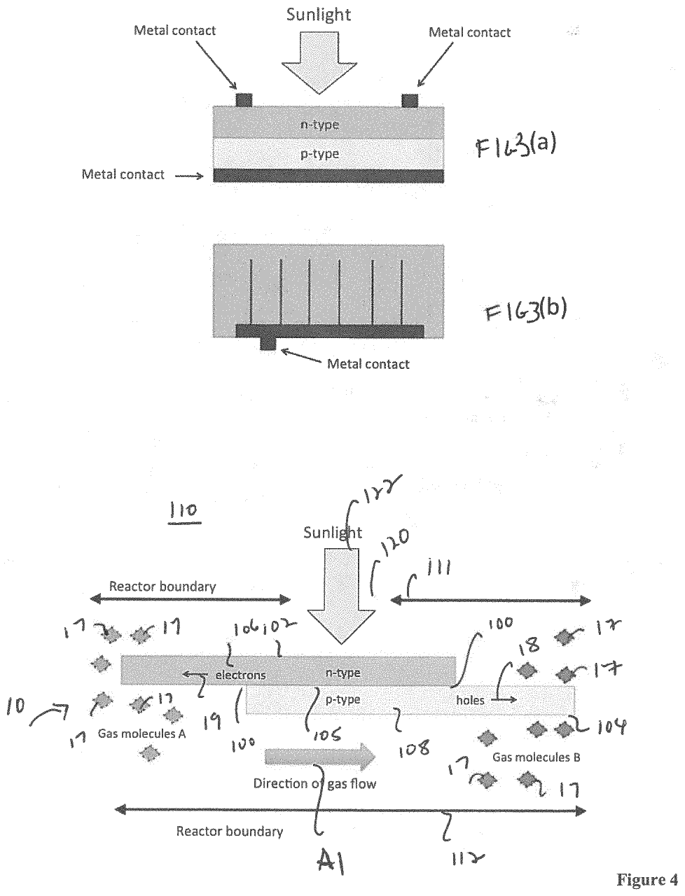

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

Having summarized the invention, the invention may be further understood by reference to the following detailed description and non-limiting examples.

FIG. 4 is a schematic diagram of photocatalytic device 10. A pn-junction 100 is formed, to which there is spatial extent of n-type region 102 and p-type region 104 that are not in contact with the other. Electrons 19 generated in space-charge region 105 of pn-junction 100 are, due to the built-in electric field inherent in pn-junctions, swept into n-type material 106 of n-type region 102, while holes 18 are, for the same reason, swept into p-type material 108 of p-type region 104.

Holes 18 are free to travel along the length of p-type material 108, manifest in thermal diffusion, where they are available to react with, such as oxidize, passing molecules 17 in gas or liquid phase. For example, it is known that holes (h⁺) react with adsorbed H₂O molecules to produce hydroxyl radicals (OH^{•}) and protons (H⁺). Electrons 19 are free to travel along the length of n-type material 106 and similarly reduce passing molecules 17 in gas or liquid phase. The carbine pathway, for example, a suggested route by which CO₂ is photocatalytically converted to CH₄, begins with the injection of a single electron into the adsorbed CO₂, forming an anion radical CO₂^{•-}. The surface-adsorbed CO2^{•-} radical reacts with e⁻ and H⁺, producing CO.

Photocatalytic device 10 within photocatalytic reactor 110 having reactor boundary 111 and reactor boundary 112. Since there is a directional flow within photocatalytic reactor 110 as shown by arrow A₁, be it gas or liquid phase, reactions take place sequentially, thus increasing specificity while minimizing the chance for back-reactions. In this embodiment pn-junction 100 is within photocatalytic reactor 110, the closed environment wherein reactions take place, with an electromagnetically transparent window 120 for the radiation 122, such as sunlight, to enter upon pn-junction 105. I is understood that since there are no metal contacts electromagnetic radiation may be incident upon either or both of the n-type region 102 and p-type region 104. Photocatalytic device 10 is applicable to any type of semiconductor, including silicon, zinc oxide, tin oxide, niobium oxide, vanadium oxide, copper oxide, titanium oxide, and iron oxide, and the like. While choice of a specific semiconductor composition or compositions can be varied, the key design parameter is the engineered spatial separation of electrons 19 and holes 18, and subsequent controlled introduction of electrons 19 and holes 18 into the reaction process.

The surface area of the pn-junction 100 can be in a range from about 1 mm² to about 2,500 cm², while the spatial extent of the isolated n-type and p-type regions can be anywhere from nanometers to meters, as desired, with specific design parameters dependent upon process details such as a quantity of electrons 19 and holes 18 generated by the incident radiation, rate of reactant flow, nature of the molecules being reduced or oxidized, desired specificity to be achieved, and temperature.

Pn-junction 100 can be fabricated by a semiconductor that includes one or more materials selected from C, Si, Ge, Sn, SiC, Se, Te, BN, BP, BAs, B₁₂As₂, AlN, AlP, AlAs, AlSb, GaN, GaP, GaAs, GaSb, InN, InP, InAs, InSb, CdSe, CdS, CdTe, ZnO, ZnSe, ZnS, ZnTe, CuCl, Cu₂S, PbSe, PbS, PbTe, SnS, SnS₂, SnTe, Zn₃P₂, TiO₂, Cu₂O, CuO, UO₂, Bi₂O₃, SnO₂, BaTiO₃, SrTiO₃, LiNbO₃, La₂CuO₄, MoS₂, GaSe, SnS, Bi₂S₃, NiO, EuO, EuS, CrBr₃, CInSe₂, AgGaS₂, ZnSiP₂, Cu₂ZnSnS₄, Cu₂SnS₃, or Cu_{1.18}Zn_{0.40}Sb_{1.90}S_{7.2}. Pn-junction 100 can be fabricated by a system of semiconducting materials that includes one or more materials selected from AlGaN, AlGaP, InGaN, InGaAsSb, GaAsN, GaAsP, CdZnTe, AlₓIn₁₋ₓAs, InₓGa₁₋ₓP, InₓGa₁₋ₓAs, AlₓGa₁₋ₓAs, Si₁₋ₓGeₓ, or Si₁₋ₓSnₓ.

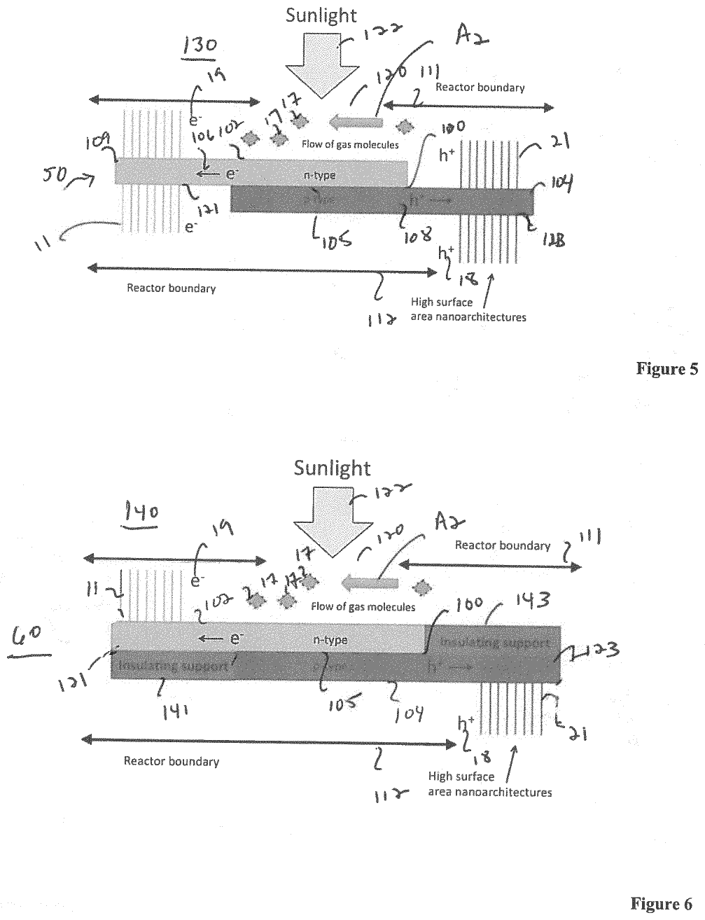

FIG. 5 is a schematic diagram of photocatalytic device 50. Pn-junction 100 is formed, to which there is spatial extent of n-type region and p-type regions that are not in contact with the other. Electrons 19 are free to travel along the length n-type material 106 , of n-type region 102 where they are available to react with, such as reduce, passing molecules 17, be they in gas or liquid phase, while holes 18 are free to travel along the length of p-type material 108 and similarly oxidize passing molecules 17, be they in gas or liquid phase. N-type region 102 has built upon it, or deposited upon it, or built from it, a high surface area n-type material architecture 11. N-type material architecture 11 can include arrays of nanotubes, nanorods, nanowires, nanofeathers, or nanoplates, and the like to promote interaction with passing reactant molecules 17. P-type region 104 has built upon it, or deposited upon it, or built from it, a high surface area p-type material architecture 21. P-type material architecture 21 can include arrays of nanotubes, nanorods, nanowires, nanofeathers, or nanoplates, and the like, to promote interaction with passing reactant molecules 17. The high surface area n-type material architecture 11 built upon n-type substrate 121 can be built of the same composition as n-type substrate 121. Alternatively, n-type material architecture 11 built upon n-type substrate 121 can be built of a different composition as n-type substrate 121. For example, the n-type material architecture 121 can be built of TiO₂ and n-type substrate 121 can be ZnO. The high surface area p-type material architecture 21 built upon p-type substrate 123 can be built of the same composition as p-type substrate 123. Alternatively, p-type material architecture 21 built upon p-type substrate 123 can be built of a different composition as p-type substrate 123.

Since there is a directional flow as shown by arrow A₂ within photocatalytic reactor 130, and the passing molecules 17 are exposed to holes 18 in one location and electrons 19 in another, chemical reactions take place sequentially, thus product specificity is increased and the chance for back-reactions minimized. Pn-junction 100 is within photocatalytic reactor 130, the closed environment wherein reactions take place, with an electromagnetically transparent window 120 for the radiation to enter upon pn-junction 100. It is understood that since there are no direct metal contacts electromagnetic radiation can be incident upon either or both of n-type region 102 and p-type region 104. The described photocatalytic device 130 is applicable to any type of semiconductor.

FIG. 6 is a schematic diagram of photocatalytic device 60 in which photocatalytic device 60 has been fabricated in wafer form. Electron-hole pairs formed within the planar pn-junction 100, due to absorption of electromagnetic energy, are separated, due to the built-in electric field across the pn-junction 100, with electrons 19 going to the n-type semiconductor of n-type region 102 and holes 18 into the p-type semiconductor of p-type region 104. Pn-junction 100 is within photocatalytic reactor 140, the closed environment wherein reactions take place, with an electromagnetically transparent window 120 for the radiation to enter upon pn-junction 100. Insulating support 141 can extend from n-type substrate 121 and insulating support 143 can extend from p-type substrate 123. The spatial extent of n-type region 102 and p-type region 104, along which, respectively, electrons 19 and holes 18 are free to traverse, allow holes 18 and electrons 19 to interact with passing molecules 17 independently of each other. Arising from p-type region 104 and n-type regions 102 are, respectively, p-type high-surface area architecture 123 and n-type high-surface area architecture 121, such as arrays of nanowires, nanotubes, nanorods, and nanofeathers, and the like, that enable greater interaction with adsorbed or adjacent molecules.

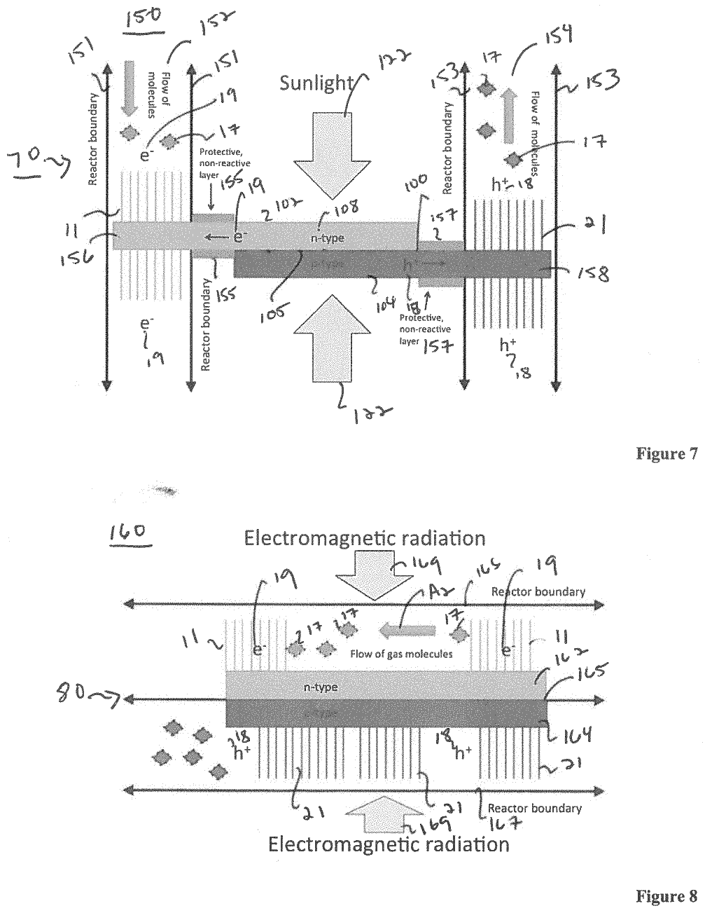

FIG. 7 is a schematic diagram of photocatalytic device 70. Pn-junction can be illuminated by electromagnetic radiation 122 from one or both sides, is exterior to photocatalytic reactor 150. Electrons 19 generated in the space-charge region 105 of the pn-junction 100 are, due to the built-in electric field inherent in pn-junctions 100, swept into n-type material 106 of n-type region 102, while holes 18 are, for the same reason, swept into p-type material 108 p-type region 104. Electrons 19 and holes 18 are conveyed into reactor 150, respectively, by n-type region 102 and p-type region 104 and members. This implementation can be particularly useful to the conversion of liquid-phase reactants, in which the liquid is opaque to incident radiation. Photocatalytic reactor 152 is within reactor boundaries 151. Photocatalytic reactor 154 is within reactor boundaries 153. Photocatalytic reactor 152 and photocatalytic reactor 154 can be connected, or can be separate reactors. Protective non-reacting layer 155 can extend from n-type substrate 156 and protective non-reacting layer 157 can extend from p-type substrate 158.

N-type region 102 has built upon it, or deposited upon it, or built from it, a high surface area n-type material architecture 11. N-type material architecture 11 can be arrays of nanotubes, nanorods, nanowires, nanofeathers, or nanoplates, and the like, to promote interaction with passing reactant molecules. Similarly, as depicted, p-type region 104 has built upon it, or deposited upon it, or built from it, a high surface area p-type material architecture 21. P-type material architecture 21 can be it arrays of nanotubes, nanorods, nanowires, nanofeathers, or nanoplates, and the like, to promote interaction with passing reactant molecules 17. The high surface area n-type material architecture 11 built upon n-type substrate 121 can be built of the same composition or semiconductor as n-type substrate 121. Alternatively, n-type material architecture 11 built upon n-type substrate 121 can be built of different composition as n-type substrate 121. The high surface area p-type material architecture 21 built upon p-type substrate 123 can be built of the same composition as p-type substrate 123. Alternatively, p-type material architecture 21 built upon p-type substrate 123 can be built of a different compositions as p-type substrate 123.

FIG. 8 is a schematic diagram of photocatalytic device 80 in which photocatalytic device 80 has been fabricated in the form of a planar wafer. Electron-hole pairs formed within planar pn-junction 165 due to absorption of electromagnetic energy 169 are separated, due to the built-in electric field across pn-junction 165, with electrons going to the n-type semiconductor and holes into the p-type semiconductor. Arising from p-type region 164 and n-type region 162 are, respectively, p-type high-surface area architecture 21 and n-type high-surface area architecture 11. P-type high-surface area architecture 21 and n-type high-surface area architecture 11 can include arrays of nanowires, nanotubes, nanorods, nanofeathers, and the like, that enable greater interaction with adsorbed or adjacent molecules. Photocatalytic reactor 160 is within reactor boundaries 166 and 167. The portion of photocatalytic reactor 160 in which holes 18 interact with passing molecules is separate from the portion of the photocatalytic reactor 160 in which electrons 19 interact with passing molecules 17.

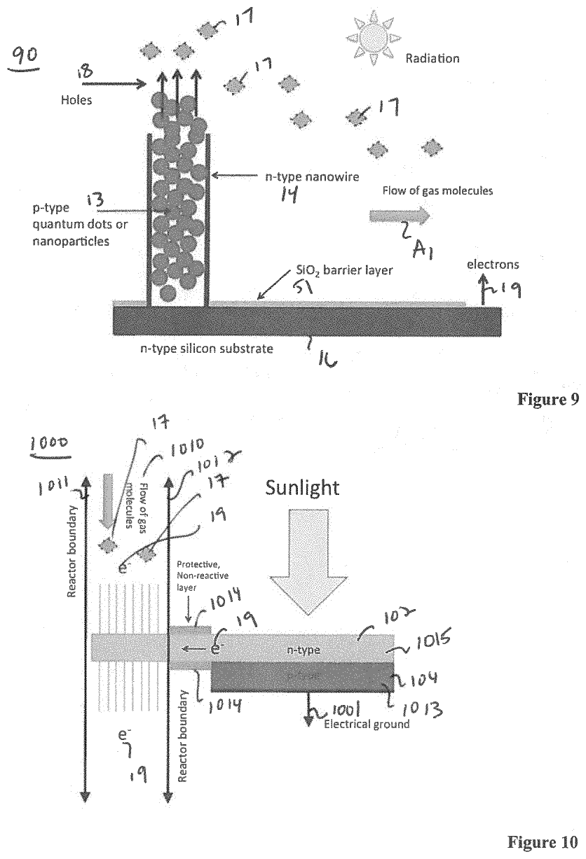

FIG. 9 is a schematic diagram of photocatalytic device. Substrate 16 is formed of n-type silicon, from which an array 12 of nanowires 14 has been grown. Nanowires 14 can be n-type nanowires. Nanowires 14 have been intercalated with nanoparticles 13. Nanoparticles 13 can be p-type nanoparticles. Electrons 19 generated within nanoparticles 13 migrate to nanowires 14, while holes 19 generated in nanowires 14 migrate to nanoparticles 13. Electrons 19 within nanowires 14 are free to thermally diffuse throughout the substrate 16, which allows for electrons 19 to react, in this example, with gas molecules 17 at a distance from where holes 18 are exposed to the reactants, allowing for separation of reaction steps improving product selectivity and minimizing unwanted back-reactions. SiO₂ barrier layer 51 is formed on substrate 16.

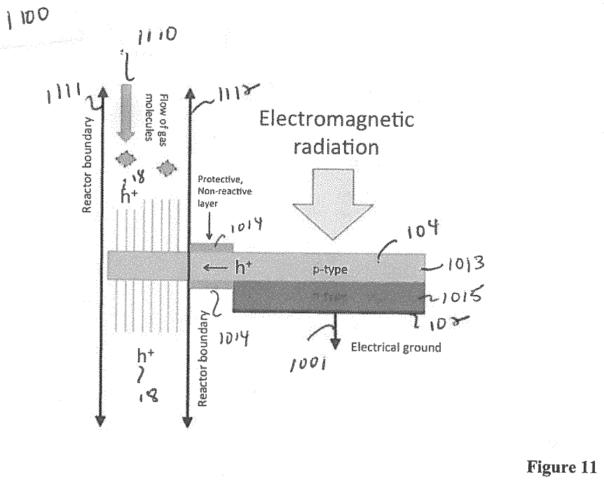

FIG. 10 is a schematic diagram of photocatalytic device 1000. P-type region 104 of p-type substrate 1013 is electrically grounded with ground 1001. Accordingly, radiation-generated holes 18 are not available to do useful work. Radiation-generated electrons 19 remain, and by passing along an n-type region 104 are made available to passing molecules 17. Photocatalytic reactor 1010 is within reactor boundaries 1011 and 1012. Protective non-reacting layer 1014 can extend from n-type substrate 1015. It is understood that the charge polarities of FIG. 10 can be reversed, n-type to p-type, with the n-type region 102 grounded and holes 18 made available to the reactant stream of molecules, as illustrated in reactor 1110 as shown in FIG. 11. N-type region 104 of n-type substrate 1015 is electrically grounded with ground 1001. Protective non-reacting layer 1014 can extend from p-type substrate 1013. Photocatalytic reactor 1110 is within reactor boundaries 1111 and 1112.

It is to be understood that the above-described device embodiments are illustrative of only a few of the many possible specific embodiments, based upon the collection and separation of electrons and holes to promote separate chemical reactions. Numerous and varied semiconductor compositions can be readily devised in accordance with the presented principles by those skilled in the art which are to be considered within the spirit and scope of the invention.

### Use of Photocatalytic Devices for Photoconversion of CO₂ to Fuel

In yet a further aspect, a method for photocatalytically converting carbon dioxide into useful reaction products comprises introducing a reactant gas such as carbon dioxide alone, mixtures of carbon dioxide and hydrogen-containing gases such as water vapor, carbon dioxide and hydrogen, and mixtures of carbon dioxide with hydrogen-containing gases such as water vapor and other reactants as may be present or desirable such as fossil fuel derived products, into a reaction chamber in the presence of any one or more of the photocatalytic devices disclosed herein and in the presence of radiation to generate reaction products in the form of, for example, hydrocarbons, hydrogen, carbon monoxide, mixtures thereof, and other products as may be present or desirable.

Any one or more of the photocatalytic devices such as those described above may be used alone or in combination to effect photocatalytic conversion of any one or more of carbon dioxide alone, mixtures of carbon dioxide and hydrogen-containing gases such as water vapor, and mixtures of carbon dioxide, hydrogen-containing gases such as water vapor and other reactants as may be present or desirable to generate reaction products in the form of, for example, hydrocarbons, hydrogen, carbon monoxide, mixtures thereof, and other products as may be present or desirable. Hydrocarbon reaction products may include but are not limited to alkanes such as methane, ethane, propane, butane, pentane, hexane and mixtures thereof, olefins such as ethylene, propylene, butylene, pentene, hexane or mixtures thereof, and branched paraffins such as isobutene, 2,2-dimethyl propane, 2-methyl butane, 2,2-dimethyl butane, 2-methyl pentane, 3-methyl pentane and mixtures thereof. The reaction products may be further processed and refined to yield hydrogen-based fuels and other products, synthesis gas (“syngas”) and derivatives of syngas (which may include hydrocarbon-based fuels and other products), and the like.

Batch processing, continuous flow-through processing, or combinations thereof may perform the methods disclosed herein for photocatalytic conversion. Both batch and continuous flow-through processes may be employed with gaseous carbon dioxide sources as well as supercritical carbon dioxide sources. Where open-ended flow-through type devices are employed they may be physically supported, for example, without limitation, on a mesh screen or the like, and may be planar or may be cylindrically shaped or in any other geometry or configuration as may be desired for different applications. The photocatalytic devices may be fabricated such that where electrons are made available to react with passing gas molecules is spatially separated from where holes are made available to react with passing gas molecules.

Photocatalytic conversion of an input reactant gas, such as any one or more of carbon dioxide alone, mixtures of carbon dioxide and hydrogen-containing gases such as water vapor, and mixtures of carbon dioxide, hydrogen-containing gases such as water vapor and other reactants as may be present or desirable, may be performed by admitting the input reactant gas into a reaction cell in the presence of one or more photocatalytic devices while admitting radiation into the reaction cell. Reaction cells for use in such manner generally include one or more inlets and outlets for admitting input gases into the cell and a window for admitting radiation, such as sunlight, into the cell. Input gases may be admitted as a mixture or may be admitted independently for mixing within the reaction cell. Preferably, the input reactant gases may be admitted as a mixture of carbon dioxide and hydrogen-containing gases such as water vapor.

Concentrators such as lenses, mirrors and the like, and/or other conventional optical devices and methods, may be used to distribute, separate, and/or increase the intensity of the radiation onto the photocatalyst present in the cell to enable use of higher input flow rates of the reactant gas(es) to enable increased generation rates of reaction products. The reaction products generated in conversion of mixtures of input gases may be analyzed by known methods such as gas chromatography equipped with flame ionization, pulsed discharge helium ionization, and thermal conductivity detectors.

What is claimed is:

1. A photocatalytic device comprising in part of a pn-junction that as a result of absorbing electromagnetic radiation generates electrons and holes; one or more separate n-type elements, in contact with the n-type element of the pn-junction but not the p-type element, allow the electrons to diffuse away from the junction an arbitrary spatial distance, and one or more separate p-type elements, in contact with the p-type element of the pn-junction but not the n-type element, allow the holes to diffuse away from the junction an arbitrary spatial distance, wherein apart from the p-type elements, one or more of the n-type elements are exposed to reactant molecules, with the electrons therein driving one or more chemical reactions and apart from the n-type elements, one or more of the p-type elements are exposed to reactant molecules, with the holes therein driving one or more chemical reactions.

2. The device of claim 1 wherein the photocatalytic device is placed within a reactor.

3. The device of claim 2 wherein the reactant molecules are in the gas phase or liquid phase.

4. The device of claim 1 wherein the radiation absorbed by the photocatalytic device, in turn generating electrons and holes, possesses a wavelength from between 0.01 μm and 300 cm.

5. The device of claim 1 wherein the pn-junction is fabricated by a semiconductor that includes one or more materials selected from C, Si, Ge, Sn, SiC, Se, Te, BN, BP, BAs, B₁₂As₂, AlN, AlP, AlAs, AlSb, GaN, GaP, GaAs, GaSb, InN, InP, InAs, InSb, CdSe, CdS, CdTe, ZnO, ZnSe, ZnS, ZnTe, CuCl, Cu₂S, PbSe, PbS, PbTe, SnS, SnS₂, SnTe, Zn₃P₂, TiO₂, Cu₂O, CuO, UO₂, Bi₂O₃, SnO₂, BaTiO₃, SrTiO₃, LiNbO₃, La₂CuO₄, MoS₂, GaSe, SnS, Bi₂S₃, NiO, EuO, EuS, CrBr₃, CInSe₂, AgGaS₂, ZnSiP₂, Cu₂ZnSnS₄, Cu₂SnS₃, or Cu_{1.18}Zn_{0.40}Sb_{1.90}S_{7.2}.

6. The device of claim 1 wherein the pn-junction is fabricated by a system of semiconducting materials that includes one or more materials selected from AlGaN, AlGaP, InGaN, InGaAsSb, GaAsN, GaAsP, CdZnTe, AlₓIn₁₋ₓAs, InₓGa₁₋ₓAs, AlₓGa₁₋ₓAs, Si₁₋ₓGeₓ, or Si₁₋ₓSnₓ.

7. The device of claim 1 wherein the composition of the pn-junction is tuned to achieve either broad spectrum radiation absorption, the absorption of a specific wavelength, or the absorption of a specific band of wavelengths.

8. The device of claim 1, wherein the pn-junction is comprised of the same semiconductor composition.

9. The device of claim 1, wherein the pn-junction is comprised of semiconductors of different composition.

10. The device of claim 1 wherein one or more n-type elements has upon it high surface area n-type charge-transporting architectural features, the features being an ordered or disordered array of nanowires, nanotubes, nanorods, nanofeathers, or nanoplates.

11. The device of claim 10 wherein the high surface area material nanoarchitecture is a mesoporous aggregate of said geometries.

12. The device of claim 10 wherein the length of the features is more than about 5 nm and less than about 100 mm.

13. The device of claim 10 wherein the high surface area material nanoarchitecture is made of one or more n-type semiconductors.

14. The device of claim 10 wherein crystallites, quantum dots, or nanoparticles of one or more co-catalysts are deposited on one or more surfaces of the n-type elements, wherein the co-catalyst is selected from the group consisting of graphene, graphene oxide, boron nitride, Ag, As, Au, Bi, Cd, Co, Cu, CuO, Cu₂O, Fe, Ga, Ge, In, Ir, Ni, Pb, Pd, Pt, Rh, Sb, Si, Sn, Ta, Tl, W, Zn or mixtures thereof.

15. The device of claim 1 wherein one or more of the p-type elements has upon it high surface area p-type charge-transporting architectural features, the features including an ordered or disordered array of nanowires, nanotubes, nanorods, nanofeathers, or nanoplates.

16. The device of claim 15 wherein the high surface area material nanoarchitecture is a mesoporous aggregate of said features.

17. The device of claim 15 wherein the high surface area material nanoarchitecture is made of one or more p-type semiconductors.

18. The device of claim 15 wherein crystallites, quantum dots, or nanoparticles of one or more co-catalysts are deposited on one or more surfaces of the p-type elements, wherein the co-catalyst is selected from the group consisting of graphene, graphene oxide, boron nitride, Ag, As, Au, Bi, Cd, Co, Cu, CuO, Cu₂O, Fe, Ga, Ge, In, Ir, Ni, Pb, Pd, Pt, Rh, Sb, Si, Sn, Ta, Tl, W, Zn or mixtures thereof.

19. The photocatalytic device of claim 1 physically oriented to receive maximum incident radiation.

20. A method for photocatalytically converting a first gas into reaction products comprising any one or more other gases, or combinations thereof, comprising exposing a reactant gas comprised at least in part of the first gas to the device of claim 1 and electromagnetic radiation to generate the reaction products.
